(19) United States
(12) Patent Application Publication
(10) Pub. No.: US 2006/0287217 A1
(43) Pub. Date: Dec. 21, 2006

(54) Pre-moistened eraser and cleaner for white board

(75) Inventors: Peter E. Keilman, Kansas City, MO (US); Paul M. Taylor, Overland Park, KS (US); Khue Vue, Olathe, KS (US); Christopher J. Plotz, Olathe, KS (US)

Correspondence Address: Levenfeld Pearlstein, LLC (ILLINOIS TOOL WORKS), 2 North LaSalle Street, Suite 1300, CHICAGO, IL, 60602, US

(73) Assignee: Illinois Tool Works, Inc., Glenview, IL (US)

(21) Appl. No.: 11/155,432

(22) Filed: Jun. 17, 2005

(51) Int. Cl. C11D 3/37

(52) U.S. Cl. 510/499

(57) ABSTRACT

An eraser/cleaner for a white marker board is formed from a substrate for absorbing a liquid and capable of retaining contaminant particles and an aqueous cleaning solution absorbed in the substrate. The cleaning solution is formulated from an alcohol present in a concentration of about 0.01 percent to about 40.0 percent by weight of the cleaning solution, a glycol ether present in a concentration of about 1.0 percent to about 15.0 percent by weight of the cleaning solution, a chelating agent present in a concentration of about 0.005 percent to about 1.0 percent by weight of the cleaning solution, a surfactant present in a concentration of about 0.01 percent to about 5.0 percent by weight of the cleaning solution and water present in a concentration of about 50.0 percent to about 90.0 percent by weight of the cleaning solution.

### BACKGROUND OF THE INVENTION

The present invention pertains to a cleaner. More particularly, the present invention relates to a pre-moistened one-step eraser and cleaner for removing ink from a white marker board.

A white marker board which (can be in a light shade of tan) is a generally vertically mounted writing surface, that is written upon with felt-tipped pens. The pens dispense a contrasting color ink that “dries” on the board. The writing is of a non-permanent ink which when “erased” becomes a loose dust that is removed from the board with the use of an eraser. These are commonly referred to a dry markers.

Typically, the white board is erased with a traditional felt-type or foam-type eraser, originally designed for use on black slate boards. However, the use of a traditional felt (or foam type) eraser designed for slate blackboards presents many problems for white board use. For example, a felt eraser is intended to remove white chalk dust from the porous surface of a slate board. Excess chalk dust that is not held by the eraser, can drop to the chalk tray, leaving the blackboard a dark shade of gray (due to the chalk dust residue), but sufficiently dark to contrast with newly applied white chalk. The chalk dust drops from the board to the chalk tray, or is picked up by a clean felt eraser, since no static charges are generated during this procedure.

Moreover, the felt eraser re-fills pores in the slate board with chalk dust during the erasing operation, which results in a “chalked-in” board at all times. It is interesting to note that a brand new blackboard must be “chalked in” to prevent permanent “ghosts” or shadows that would occur if it were immediately written upon with chalk.

A new white board, on the other hand, has a non-porous finish. The white board surface is typically porcelain, melamine (resin finish) or plastic (such as polyester. Erasing marker dust from a white marker board using a conventional felt eraser causes static charges to build up through triboelectric forces, particularly on melamine and plastic surfaces. And, because marker dust is not as dense as chalk dust, it does not drop off white boards; rather it tends to adhere to the board surface. This clinging problem is especially prevalent when static charges are generated. As a result, when the felt eraser becomes “saturated” with synthetic light, marker board ink dust, it no longer removes the dust, but instead redeposits, or pushes the dry ink to other portions of the board. This condition makes the white board irregularly blotchy with dust, and very difficult to read, as well as unattractive. Moreover, the dust tends to migrate from the board onto clothing and nearby objects.

A white board, after being subjected to the chemical solvents present in most of the marker pen inks and various types of chemical cleaners used to clean the board, gradually goes from a nonporous glazed surface (when new) to a more open porous surface. This condition is similar to a porcelain sink that has been scoured too often and from which the porcelain glaze has been removed. This leads to a condition referred to as “ghosting”. Ghosting occurs as marker pen ink flows down into the (now) porous surface and dries. When a white board surface has been ghosted, only the surface dust is removed when it is conventionally erased. The dried ink trapped below the surface remains there, creating “ghosts” or shadows of previous writings.

Many attempts to create effect erasers have been made. For example a renewable surface dust cloth, that is composed of a plurality of thin, fibrous, loosely compacted layers has been used. However, this cloth does not provide the convenience and hygienic factor of keeping the user's hand from touching a partially used surface, or one that contains an oil conditioner. Another cleaner is known that includes a handle to which a laminated pad is mounted. The pad includes a number of plies or sheets of fabric that have been impregnated with a chemical to facilitate cleaning and prevent chalk dust. However, the plies or sheets that make up the pad are vertically stitched to a tape, so that side portions of the sheets can be folded to bring surfaces of the plies to the front for use, and, it is necessary to clean the plies to obtain any reasonable economic life of the device.

Still another device is a hand held eraser, that includes a handle carrying a pad of material. However, this device does not provide any structure that allows for conveniently removing a soiled sheet of material without touching the soiled surface. Yet another device is a roll of material that has been found to be unsatisfactory for white board eraser use when the bulk of this device is considered.

Still other devices use adhesives to hold together adjacent layers of material. Adhesively held layers of material are susceptible to many shortcomings. For example, the leading edges of the material tend to roll up due to friction, exposing the adhesive layer to the surface to be cleaned. In addition, adhesive transferred to the board can be deleterious to long-term use of the board as a writing surface, and can also trap loose marker board dust.

One known white board eraser holds multiple replacement tissues. However, the used tissues are not easily disposed of as the user must handle the remaining stack of replacement tissues each time they are changed, which requires disassembling the eraser's components.

Accordingly, there is a need for a white board cleaner/eraser that is easy to use, non-toxic and non-flammable. Such a cleaner absorbs dust and is comfortable to hold and use. Desirably, such a cleaner is lint free and provides one-step erasing and cleaning.

### BRIEF SUMMARY OF THE INVENTION

An eraser/cleaner for a white marker board is formed as a substrate (typically in towel form) the absorbs liquid and is capable of retaining contaminant particles. An aqueous cleaning solution is absorbed in the substrate.

The cleaning solution is formulated from an alcohol present in a concentration of about 0.01 percent to about 40.0 percent by weight of the cleaning solution, a glycol ether present in a concentration of about 1.0 percent to about 15.0 percent by weight of the cleaning solution, a chelating agent present in a concentration of about 0.005 percent to about 1.0 percent by weight of the cleaning solution, a surfactant present in a concentration of about 0.01 percent to about 5.0 percent by weight of the cleaning solution and water present in a concentration of about 50.0 percent to about 90.0 percent by weight of the cleaning solution.

The white board cleaner/eraser is easy to use, non-toxic and non-flammable. The substrate (towel) saturated with the cleaner solution absorbs dust and is comfortable to hold and use. The towel is lint free and the eraser/cleaner provides one-step erasing and cleaning.

In a present cleaning solution, the surfactant is a fluorosurfactant present in a concentration of about 200 parts per million by weight of the cleaning solution. The fluorosurfactant is a fluoroaliphatic amine oxide.

One fluorosurfactant is of the general formula:

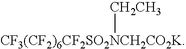

Another fluorosurfactant is of the general formula:
(R_{f}CH₂CH₂O)—P—O(ONH₄)₂, where R_{f} is F[CF₂CF₂]ₓ, where x is 3 to 8.

The alcohol is an aliphatic lower alcohol having from two to six carbon atoms. Preferably, the alcohol is propanol, ethanol, isopropanol, methanol or a mixture thereof and most preferably, the alcohol is ethanol.

The glycol ether is preferably ethylene glycol monobutyl ether, propylene glycol tertiary butyl ether or a mixture thereof. The water is preferably deionized (or reverse osmosis processed) water having a hardness of less than 100 parts per million by weight of the water.

A preferred substrate is formed as a disposable towel. The towel can be formed as a non-woven fibrous material. The material can be formed from polymeric fiber, natural fiber or a blend of polymeric fibers and natural fibers.

The polymeric fibers can be a polypropylene fiber, a polyethylene fiber or a combination of polypropylene and polyethylene fibers. The fibrous material can be biodegradable.

A preferred eraser/cleaner includes a container having a sealed opening in which a plurality of eraser/cleaners are disposed. The container preferably has a dispensing opening and a cover overlying the dispensing opening to retard evaporation of the cleaning solution.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of an exemplary container for storing a plurality of eraser/cleaner articles, formed as towels, for use on white marker boards, the container formed as a cylindrical container in which the towels are in a roll form, and from which the towels are withdrawn from the center of the roll through and opening in a lid of the container; and

FIG. 2 is a top view of another exemplary container, formed in a rectangular shape, the towels being interfolded with one another and having a slot-like opening for withdrawing the towels.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

A present pre-moistened eraser and cleaner is provided as a towel that is capable of absorbing and retaining a predetermined amount of a fluid. A preferred towel is a uniformly moist towel. The absorbent characteristics of the towel can be achieved by use of material formed with a system of voids or pores that absorb and retain the liquid cleaner, such as by capillary action. The towel is preferably capable of readily releasing the liquid during use. The towel has a cleaning side and a converse (or holding) side. The specific void or pore volume of the structure of the towel regulates the amount of fluid which can be retained in the towel. In one embodiment, the towel is formed from a non-woven material that has an affinity to absorb the fluid and is able to absorb and otherwise retain inks that have been removed from the treated white board surface.

A preferred saturated towel not only acts as a dust magnetic, it also serves as an antistatic agent during the erasing procedure, which is especially desirable when used-on a synthetic (e.g., melamine or polyester) white board surface. The fluid has a viscosity sufficient for ready absorption into the pores or voids of the towel through capillary action. The towel has sufficient void volume to prevent oil from migrating to the converse surface, and contaminating the user's hand with ink.

The non-woven material contemplated for use as the towel can be any of a number of substrates. These fibers can be natural or manufactured or a combination of natural and manufactured. The fibers can be regenerated and synthetic. Contemplated fibers include polypropylene, polyester nylon, rayon, cotton, wood pulp, cellulose, polyethylene, polyvinyl, viscose, polyurethane and blends thereof.

The white board surface cleaning composition of the present invention is an aqueous mixture of an alcohol, a glycol ether, and surfactants. Suitable surfactants are sodium octyl sulfonate and a fluorosurfactant. A fluorosurfactant present in a concentration of equal to or less than 400 parts per million (ppm), and preferably equal to or less than 200 ppm by weight of the fluid. Other conventional constituents such as perfumes, anti-fog agents and the like can be added in amounts that do not adversely affect the beneficial properties of the fluid composition by adding substantial residue particles.

Lower aliphatic alcohols are particularly suitable as the alcohol component, and specifically denatured lower alcohols are preferred. Any lower alcohol having from 2 to 5 carbon atoms, such as propanol, ethanol, isopropanol, methanol and mixtures thereof, are most preferred. A present fluid composition is prepared using isopropanol as the alcohol component. The isopropanol flash dries and evaporates quickly to provide a cleaning composition that is easily removed with very little wiping. As such, the isopropanol composition is less likely to streak or show spots. A suitable amount of the lower alcohol is about 1 percent to about 40 percent by weight of the fluid, preferably about 5 percent to about 30 percent by weight, and most preferably about 10 percent to about 25 percent by weight, based on the total fluid composition.

The glycol component can include any glycol having from 2 to 6 carbon atoms. Glycol ethers are preferred. Suitable glycol ethers include dipropylene glycol methyl ether, diethylene glycol methyl ether, diethylene glycol ethyl ether, diethylene glycol propyl ether, ethylene glycol propyl ether, ethylene glycol monobutyl ether, and propylene glycol tertiary butyl ether. Most preferred are ethylene glycol monobutyl ether, and propylene glycol tertiary butyl ether. The glycol component is present in a concentration of about 1 percent to about 15 percent by weight of the fluid, preferably about 2 percent to about 10 percent by weight and most preferably about 3 percent to about 6 percent by weight, based on the total fluid composition. Mixtures of two or more of the glycols may be used with the total glycol concentration falling within the preferred concentrations.

A preferred formulation of the fluid can includes a chelating agent. A preferred chelating agent is trasodium ethylenediamine tetraacetic acid. The tetrasodium ethylenediamine tetraacetic acid is provided as an aqueous solution of about 38 percent by weight (of the chelating agent solution). It is contemplated that total concentration of the tetrasodium ethylenediamine tetraacetic acid in the formulation is about 0.010 percent to about 1.0 percent by weight, and preferably about 0.01 percent to about 0.5 percent by weight based on the total fluid composition.

A wetting agent, such as sodium octyl sulfonate is in an aqueous solution of 38 percent by weight active and is provided in an amount of equal to or less than about 0.38 percent by weight active in the total fluid composition. Suitable amount of sodium octyl sulfonate in the formulation of the present invention is equal to or less than about 0.31 percent by weight of the total fluid composition.

A surfactant can also be used fluid. A suitable surfactant is fluoroaliphatic amine oxide (a fluorosurfactant) and is provided in an amount equal to or less than about 60 ppm or about 0.0060 percent by weight active solids in the total fluid composition. Preferably, the fluorosurfactant is present in a concentration of equal to or less than about 40 ppm or about 0.0040 percent by weight active solids in the total fluid composition. Surprisingly, it has been found that the class of compounds known as fluorocarbon surfactants are particularly useful for the present cleaner due to their ability to lower surface tension and enhance wettability and foam stability at concentrations much lower than was previously thought to be effective. Water soluble anionic, non-ionic and cationic fluorocarbon surfactants are preferred, and anionic fluorosurfactants are most preferred. Particularly suitable surfactants for the present invention include fluoroaliphatic amine oxide. An example of this preferred class of fluorocarbon surfactants is represented by the following formula:

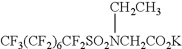

Another example of a suitable anionic fluorosurfactant is represented generally by the following formula:
(R_{f}CH₂CH₂O)—P—O(ONH₄)₂, where R_{f} is F[CF₂CF₂]ₓ, where x is 3 to 8.

One suitable commercially available fluoroaliphatic amine oxide is MASURF FS-230® from Mason Chemical Company of Arlington Heights, Ill. The two general formulas above are discussed in more detail in Wile, U.S. Pat. No. 5,415,811 which patent is commonly assigned with the present application and is incorporated herein by reference.

The fluid composition can, of course, include other adjuvants commonly used in hard surface cleaning compositions that do not add a substantial amount of residual material. Fragrance can be added in amounts ranging from 0.01 to 0.1% (by weight) with little adverse consequence.

In addition to the constituents identified above, the water that is used to formulate the aqueous solution is preferably soft, deionized (or reverse osmosis processed) water having a hardness, i.e. mineral content, of less than about 100 ppm, preferably no more than about 50 ppm and most preferably no more than about 30 ppm, by weight.

To prepare the composition of the present invention, a mixing tank is charged with deionized (or reverse osmosis processed) water and the glycol ether, alcohol, surfactant, fluorosurfactant, and fragrance. The final composition results after mixing at room temperature for about 15 minutes.

An exemplary fluid composition according to the present invention was formulated as about 19.0 percent denatured ethanol, about 4.0 percent ethylene glycol monobutyl ether, about 1.0 percent sodium octyl sulfonate, about 0.2 percent tetrasodium EDTA, about 0.30 percent fluorosurfactant and about 75.8 percent deionized water. Another exemplary composition was formulated as about 19.0 percent denatured ethanol, about 4.0 percent ethylene glycol monobutyl ether, about 1.0 percent sodium octyl sulfonate, about 0.3 percent tetrasodium EDTA, about 0.40 percent fluorosurfactant, about 0.04 percent fragrance and about 75.6 percent deionized (or reverse osmosis processed) water. The fluorosurfactant used in both the first and second exemplary compositions was MASURF FS-230® and the fragrance used in the second exemplary composition is that available as fragrance AA074197 commercially available from Arylessence, Inc. of Marietta, Ga.

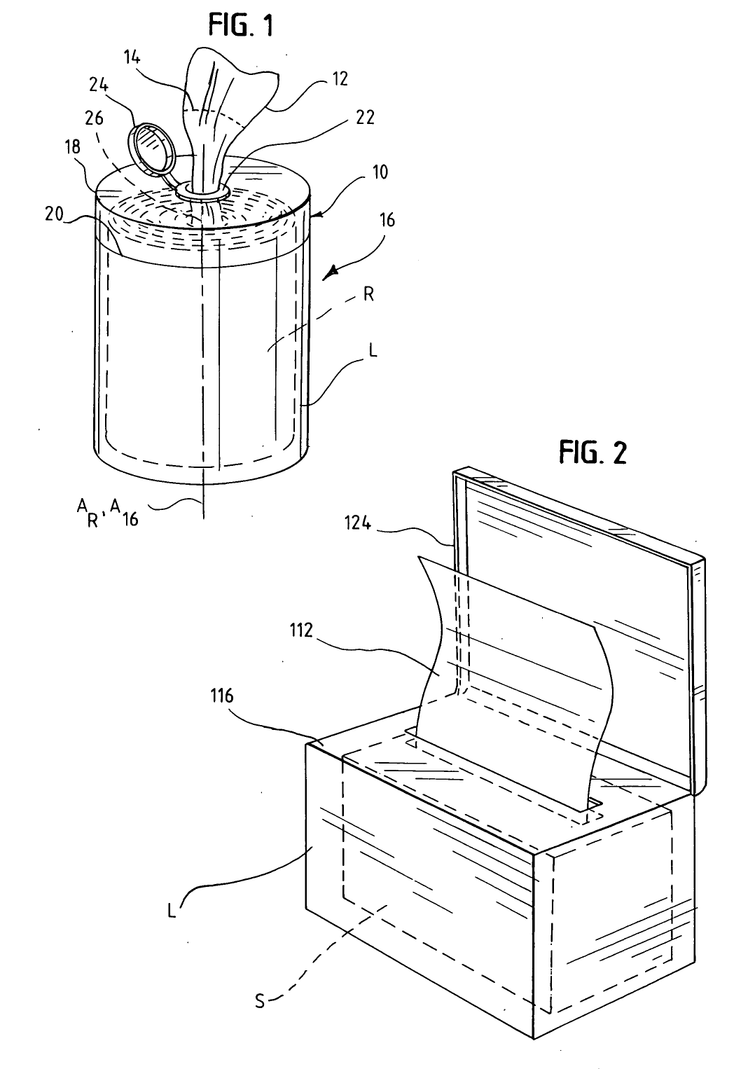

In preparing a pre-moistened eraser/cleaner 10 in accordance with the present invention, the porous, soft, non-linting article 12 (illustrated as a towel) is provided. Referring to FIG. 1, the towels 12 can be provided in a continuous, perforated roll R of towels. A line of perforation 14 between the individual towels presentsl2 a line of weakness by which the towels 12 can be separated from adjacent towels.

The towels 12 can be disposed on-end into a selectively resealable, preferably cylindrical container 16, with an axis of the cylinder A₁₆ being aligned (in an essentially vertical orientation) with an axis A_{R} of the roll R of towels. As seen in FIG. 1, the container 16 for holding the towels 12 includes a lid 18 the fits over an open end 20 of the container 16. The lid 18 includes a dispensing opening 22 that can be selectively sealed, as by a cover 24, such as the illustrated hinged cap. The dispensing opening 22 allows for the passage of towels 12 (e.g., pulling the towels) from the center 26 of the towel roll R (in the interior of the sealed container 16) via the opening 22. In this manner, individual towels 12 can be removed by pulling the towel 12 and tearing the towel 12 at the perforation line 14 located between adjacent towels.

The cover 24 can then be closed over the opening 22 to retard evaporation of the cleaning fluid L. Of course, it is anticipated that alternate embodiments of this invention could, for example, provide a stack S of individual towels 12 instead of the continuous roll R of towels 12 in a reactangular covered (124) container 116. In either case, the liquid cleaner L is added to the container 16, 116, preferably by pouring the liquid L over the roll R or stack S of towels 12, to saturate the towels 12 within the container 16, 116. A combination of the viscosity of the emulsion and the capillary action associated with the void volume of the towel as discussed above causes the fluid to be distributed evenly throughout the roll or stack of towels. An alternative method for saturating the liquid cleaner is by means of pre towel saturation. This is accomplished via post unwind and pre perforation of a continuous roll of towels. This fully saturated roll or stack is then inserted into the finished goods container.

In use, an individual towel is removed from the container as described above an is wiped across the white board. The towel is then disposed of as waste. The solvent that remains on the board evaporates sufficiently quickly that little to no residue remains almost immediately after wiping. When properly prepared, the towel contains an amount of the liquid cleaner to removes ink dust and condition the surface of the board. Advantageously, the present cleaner towels have a greater dust holding power than previously known erasers, and permit use without the user contacting soiled eraser surfaces. Most advantageously, such a cleaner/eraser both conditions and coats the board surface with the aqueous cleaning solution. It has been found that as the towel is rubbed on the surface, it releases the liquid cleaner which functions as a dust magnetic, and acts as an antistatic agent during the erasing procedure, which is desirable true when used on a synthetic (melamine or polyester) white board surface.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. An eraser/cleaner for a white marker board, comprising:
a substrate, the substrate being for absorbing a liquid and capable of retaining contaminant particles; and
an aqueous cleaning solution absorbed in the substrate, the cleaning solution formulated from an alcohol present in a concentration of about 0.01 percent to about 40.0 percent by weight of the cleaning solution, a glycol ether present in a concentration of about 1.0 percent to about 15.0 percent by weight of the cleaning solution, a chelating agent present in a concentration of about 0.005 percent to about 1.0 percent by weight of the cleaning solution, a surfactant present in a concentration of about 0.01 percent to about 5.0 percent by weight of the cleaning solution and water present in a concentration of about 50.0 percent to about 90.0 percent by weight of the cleaning solution.

2. The eraser/cleaner in accordance with claim 1 wherein the substrate is formed as a disposable towel.

3. The eraser/cleaner in accordance with claim 1 wherein the surfactant is a fluorosurfactant present in a concentration of about 200 parts per million by weight of the cleaning solution.

4. The eraser/cleaner in accordance with claim 3 wherein the fluorosurfactant is a fluoroaliphatic amine oxide.

5. The eraser/cleaner in accordance with claim 1 wherein the alcohol is an aliphatic lower alcohol having from two to six carbon atoms.

6. The eraser/cleaner in accordance with claim 5 wherein the alcohol is propanol, ethanol, isopropanol, methanol or a mixture thereof.

7. The eraser/cleaner in accordance with claim 6 wherein the alcohol is ethanol.

8. The eraser/cleaner in accordance with claim 1 wherein the glycol ether is ethylene glycol monobutyl ether, propylene glycol tertiary butyl ether or a mixture thereof.

9. The eraser/cleaner in accordance with claim 3 wherein the fluorosurfactant is of the general formula:

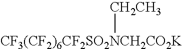

10. The eraser/cleaner in accordance with claim 3 wherein the fluorosurfactant is of the general formula:
(R_{f}CH₂CH₂O)—P—O(ONH₄)₂, where R_{f} is F[CF₂CF₂]ₓ, where x is 3 to 8.

11. The eraser/cleaner in accordance with claim 1 wherein the water has a hardness of less than 100 parts per million by weight of the water.

12. The eraser/cleaner in accordance with claim 1 wherein the substrate is formed as a non-woven fibrous material.

13. The eraser/cleaner in accordance with claim 12 wherein the non-woven fibrous material is formed from polymeric fiber.

14. The eraser/cleaner in accordance with claim 12 wherein the non-woven fibrous material is formed from natural fiber.

15. The eraser/cleaner in accordance with claim 12 wherein the non-woven fibrous material is formed from a blend of polymeric fibers and natural fibers.

16. The eraser/cleaner in accordance with claim 13 wherein the polymeric fiber is a polypropylene fiber, a polyethylene fiber or a combination of polypropylene and polyethylene fibers.

17. The eraser/cleaner in accordance with claim 12 wherein the non-woven fibrous material is biodegradable.

18. The eraser/cleaner in accordance with claim 1 including a container having a sealed opening, and wherein a plurality of eraser/cleaners are disposed in the container.

19. The eraser/cleaner in accordance with claim 18 wherein the container has a dispensing opening.

20. The eraser/cleaner in accordance with claim 19 including a cover overlying the dispensing opening.
